(19) United States
(12) Patent Application Publication
(10) Pub. No.: US 2011/0276482 A1
(43) Pub. Date: Nov. 10, 2011

(54) SYSTEM AND METHOD FOR IDENTIFYING MULTIPLE TYPES OF ELECTRONIC MONEY, AND APPARATUS APPLIED THERETO

(75) Inventor: Jong Ho Kim, Gyeonggi-do (KR)

(73) Assignee: SK TELECOM CO., LTD., Seoul (KR)

(21) Appl. No.: 13/144,909

(22) PCT Filed: May 18, 2010
(86) PCT No.: PCT/KR10/03126

§ 371 Date: Jul. 15, 2011

(30) Foreign Application Priority Data
Jun. 8, 2009 (KR) 10-2009-0050673

(51) Int. Cl. G06Q 40/00

(52) U.S. Cl. 705/41

(57) ABSTRACT

The present disclosure relates to a system and method for identifying multiple types of electronic money, and an apparatus employing the same. The system for identifying multiple types of electronic money includes an electronic money terminal apparatus capable of identifying various types of electronic money and providing an electronic money service, including charging, payment, and transfer of electronic money

### Technical Field

The present invention relates to a system and method for identifying multiple types of electronic money, and an apparatus employing the same. More particularly, the present invention relates to a system and method for identifying multiple types of electronic money, and an apparatus employing the same, which can provide an electronic money service, including charging, payment, and transfer of electronic money, by identifying various types of electronic money.

### BACKGROUND ART

In general, conventional solutions in order to remove the inconvenience and the risk of carrying of cash and achieve a more convenient financial transaction include a credit card based payment scheme, in which a predetermined amount of money is set based on credit information of a user and a use-now-pay-later system is made available to the user (i.e. the user is allowed to first use something and pay later for the use) up to the predetermined amount.

Meanwhile, an electronic money charging card has been recently developed, which digitalizes the value of money and stores data relating to the amount of electronic money in an information recording area of the card, thereby enabling direct use of the electronic money by a user of the card, beyond the conventional limited scheme allowing the virtual payment based on only the credit information of the credit card user contained in a magnetic recording surface or an information recording chip of the credit card.

As a representative example of such electronic money charging cards is a smart card equipped with a semiconductor chip having a memory means and a central processor. Moreover, it is a current trend that the smart card is implemented in the plug-in type by remarkably reducing the volume taken up by the semiconductor chip and the card so that the card can be embedded in a user terminal, such as a mobile communication terminal.

In charging electronic money for a smart card that can be mounted in a portable terminal, a predetermined amount of electronic money may be charged by connecting the smart card with an electronic money charging device off-line through direct/indirect contact, or may be charged by means of a computer terminal having a network adaptor or a mobile communication terminal on-line through the Internet or a mobile communication network.

In use of the electronic money as described above, a price may be paid in advance to an issuer of the electronic money with a predetermined money value stored in an Integrated Circuit (IC) chip embedded in the smart card. Further, the smart card has a reduced probability that it may be forged or falsified, is relatively safe even when it has been lost or stolen, and is very convenient for payment of a small amount of money.

However, in spite of the convenience of the electronic money, the electronic money is not actively used, because the electronic money has a low compatibility.

The electronic money issuers employ different payment systems based on different IC chips. Therefore, one kind of electronic money can be used only by an electronic money terminal apparatus corresponding to that kind of electronic money. Further, the user should individually arrange the electronic money for each of the electronic money issuing companies.

Further, even after the user individually obtains various types of electronic money issued by electronic money issuing companies, the user should individually select electronic money of a type compatible with an electronic money terminal apparatus, and then use an electronic money service through the selected electronic money.

Therefore, there has been a request for a solution capable of solving the above-described problems.

### DISCLOSURE

### Technical Problem

Therefore, the present invention has been made in view of the above-mentioned problems, and the present invention provides a system and method for identifying multiple types of electronic money, and an apparatus employing the same, which can implement an electronic money terminal apparatus capable of identifying various types of electronic money and providing an electronic money service, including charging, payment, and transfer of electronic money, and can automatically execute an electronic money application matching with a particular type of electronic money when an electronic money card storing the particular type of electronic money is read.

Also, the present invention provides a system and method for identifying multiple types of electronic money, and an apparatus employing the same, which can implement an electronic money terminal apparatus capable of identifying various types of electronic money and providing an electronic money service, including charging, payment, and transfer of electronic money, can easily appoint an electronic money application matching with one type of electronic money, which is most proper for a user and is selected from two or more different types of electronic money, and execute an electronic money service through the appointed electronic money application, when an electronic money card storing the two or more different types of electronic money is read.

### Technical Solution

In accordance with an aspect of the present invention, there is provided a system for identifying multiple types of electronic money, the system including: an electronic money card unit for storing a first type of electronic money; and an electronic money terminal unit for reading application identification information corresponding to the first type of electronic money from the electronic money card unit, executing a first type electronic money application corresponding to the read application identification information among stored electronic money applications, and processing an electronic money service including charging, payment, and transfer of the first type of electronic money through the first type electronic money application.

According to an embodiment of the present invention, when the electronic money card unit is an Integrated Circuit (IC) module, the system for identifying multiple types of electronic money further includes a communication terminal device unit, which is provided or tagged with the IC module and performs a communication for processing the electronic money service with the electronic money terminal unit.

In accordance with another aspect of the present invention, there is provided a system for identifying multiple types of electronic money, the system including: an electronic money card unit for storing multiple types of electronic money; and an electronic money terminal unit for reading application identification information corresponding to the multiple types of electronic money from the electronic money card unit, and, when the read application identification information includes default type application identification information, executing a default electronic money application corresponding to the default type application identification information among stored electronic money applications and processing an electronic money service including charging, payment, and transfer of the default electronic money corresponding to the default type application identification information.

According to another embodiment of the present invention, when the electronic money card unit is an Integrated Circuit (IC) module, the system for identifying multiple types of electronic money further includes a communication terminal device unit, which is provided or tagged with the IC module and performs a communication for processing the electronic money service with the electronic money terminal unit.

According to another embodiment of the present invention, when the read application identification information includes no default type application identification information, the electronic money terminal unit determines whether the multiple types of electronic money include a type of electronic money matching with the read application identification information, and executes an electronic money application corresponding to the type of electronic money matching with the read application identification information among the stored electronic money applications when the multiple types of electronic money include the type of electronic money matching with the read application identification information.

In accordance with another aspect of the present invention, there is provided an electronic money terminal unit in a system for identifying multiple types of electronic money, the electronic money terminal unit including: a storage unit for storing electronic money applications for executing an electronic money service including charging, payment, and transfer of one type of electronic money among the multiple types of electronic money, according to types of the electronic money applications; a card reader unit for reading an electronic money card storing a first type of electronic money among the multiple types of electronic money; a reading unit for reading application identification information corresponding to the first type of electronic money; and an execution unit for extracting a first type electronic money application corresponding to the read application identification information from the storage unit and executing the extracted electronic money application to process the electronic money service.

According to another embodiment of the present invention, the reading unit determines whether the read application identification information corresponds to a preset default type application set as a default, and, when the read application identification information does not correspond to the preset default type application, the reading unit additionally determines if the read application identification information corresponds to one of remaining electronic money applications among the stored electronic money applications.

In accordance with another aspect of the present invention, there is provided an electronic money terminal unit in a system for identifying multiple types of electronic money, the electronic money terminal unit including: a storage unit for storing electronic money applications for executing an electronic money service including charging, payment, and transfer of a predetermined type of electronic money among the multiple types of electronic money, according to types of the electronic money applications; a card reader unit for reading an electronic money card storing two or more types of electronic money; a reading unit for reading application identification information corresponding to each of the two or more types of electronic money; and an execution unit for determining whether the read application identification information includes default type application identification information set as a default, and, when the read application identification information includes the default type application identification information, executing a default electronic money application corresponding to the default type application identification information among the stored electronic money applications, so as to process a predetermined electronic money service.

According to another embodiment of the present invention, the reading unit determines whether the read application identification information corresponds to a preset default type application set as a default, and, when the read application identification information does not correspond to the preset default type application, the reading unit additionally determines whether the read application identification information corresponds to one of remaining electronic money applications among the stored electronic money applications.

According to another embodiment of the present invention, as a result of additional determination, when there is one type of compatible electronic money application capable of providing the electronic money service, which matches with the read application identification information, the execution unit executes the compatible electronic money application among the electronic money applications stored in the storage unit, so as to process the electronic money service.

According to another embodiment of the present invention, when there are two or more types of compatible electronic money applications capable of providing the electronic money service, which match with the read application identification information, the execution unit executes an electronic money application appointed and selected by the user from the two or more electronic money applications among the electronic money applications stored in the storage unit, so as to process the electronic money service.

According to another embodiment of the present invention, when there are two or more types of compatible electronic money applications capable of providing the electronic money service, which match with the read application identification information, the execution unit determines priorities of the compatible electronic money applications based on criteria including a balance criterion, a point criterion, and a discount rate criterion, appoints a compatible electronic money application having a highest priority, and executes the appointed compatible electronic money application among the electronic money applications stored in the storage unit, so as to process the electronic money service.

In accordance with another aspect of the present invention, there is provided a method for identifying multiple types of electronic money, the method including the steps of: reading an electronic money card storing a first type of electronic money among the multiple types of electronic money; reading application identification information corresponding to the first type of electronic money; appointing a first type electronic money application corresponding to the application identification information from a storage unit storing electronic money applications for executing an electronic money service including charging, payment, and transfer of a predetermined type of electronic money among the multiple types of electronic money, according to types of the electronic money applications; and executing the first type electronic money application to process the electronic money service.

According to another embodiment of the present invention, the step of reading application identification information includes the steps of: determining whether the read application identification information corresponds to a preset default type application set as a default; and when the read application identification information does not correspond to the preset default type application, additionally determining whether the read application identification information corresponds to one of remaining electronic money applications among the stored electronic money applications.

In accordance with another aspect of the present invention, there is provided a method for identifying multiple types of electronic money, the method including the steps of: reading an electronic money card storing two or more types of electronic money; reading application identification information corresponding to each of the two or more types of electronic money; when a result of reading of the application identification information shows that the read application identification information includes default application identification information set as a default, appointing a default electronic money application corresponding to the default application identification information from a storage unit storing electronic money applications for executing an electronic money service including charging, payment, and transfer of a predetermined type of electronic money among the multiple types of electronic money including the two or more types of electronic money, according to types of the electronic money applications; and executing the default electronic money application to process the electronic money service.

According to another embodiment of the present invention, the step of reading the application identification information includes the steps of: determining whether the read application identification information corresponds to the default application identification information set as a default; and when the read application identification information does not correspond to the preset default type application, additionally determining whether the read application identification information corresponds to one of remaining electronic money applications among the stored electronic money applications.

According to another embodiment of the present invention, the step of executing the default electronic money application includes the steps of: when a result of additional determination shows that there is one type of compatible electronic money application capable of providing the electronic money service, which matches with the read application identification information, executing the compatible electronic money application among the electronic money applications stored in the storage unit, so as to process the electronic money service.

According to another embodiment of the present invention, the step of executing the default electronic money application includes the step of: when a result of additional determination shows that there are two or more types of compatible electronic money applications capable of providing the electronic money service, which match with the read application identification information, executing an electronic money application appointed and selected by the user from the two or more electronic money applications among the electronic money applications stored in the storage unit, so as to process the electronic money service.

According to another embodiment of the present invention, the step of executing the default electronic money application includes the steps of: when a result of additional determination shows that there are two or more types of compatible electronic money applications capable of providing the electronic money service, which match with the read application identification information, determining priorities of the compatible electronic money applications based on criteria including a balance criterion, a point criterion, and a discount rate criterion, appoints a compatible electronic money application having a highest priority; and executing the appointed compatible electronic money application among the electronic money applications stored in the storage unit, so as to process the electronic money service.

### Advantageous Effects

Therefore, according to the present invention, through implementation of an electronic money terminal apparatus capable of identifying various types of electronic money and providing an electronic money service, including charging, payment, and transfer of electronic money, it is possible to automatically execute an electronic money application matching with a particular type of electronic money when an electronic money card storing the particular type of electronic money is read. Moreover, it is possible to easily appoint an electronic money application matching with one type of electronic money, which is most proper for a user and is selected from two or more different types of electronic money, and to execute an electronic money service through the appointed electronic money application, when an electronic money card storing the two or more different types of electronic money is read.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a system for identifying multiple types of electronic money according to an embodiment of the present invention;

FIG. 2 is a block diagram illustrating another type of electronic money card unit, which is an Integrated Circuit (IC) module mounted or tagged in a communication terminal device unit;

FIG. 3 is a flowchart illustrating an operation of the system for identifying multiple types of electronic money shown in FIG. 1;

FIG. 4 is a block diagram illustrating a system for identifying multiple types of electronic money according to another embodiment of the present invention;

FIG. 5 is a block diagram illustrating another type of electronic money card unit, which is an IC module mounted or tagged in a communication terminal device unit; and

FIG. 6 is a flowchart illustrating an operation of the system for identifying multiple types of electronic money shown in FIG. 4.

### BEST MODE

### Mode for Invention

Hereinafter, exemplary embodiments of the present invention will be described with reference to the accompanying drawings. However, the present invention is not limited or restricted by the embodiments thereof. In the following description, the same elements will be designated by the same reference numerals although they are shown in different drawings.

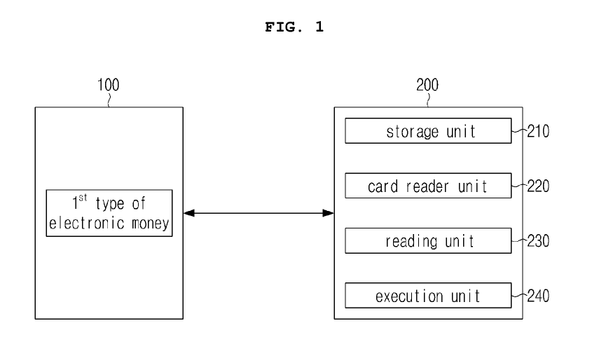

FIG. 1 is a block diagram illustrating a system for identifying multiple types of electronic money according to an embodiment of the present invention. As shown in FIG. 1 as an example, the system for identifying multiple types of electronic money includes an electronic money card unit 100 storing a first type of electronic money, and an electronic money terminal unit 200, which reads the electronic money card unit 100, reads application identification information, such as an identifier (ID), of an application corresponding to the first type of electronic money, and executes a first type electronic money application corresponding to the read application identification information, so as to process an electronic money service including charging, payment, and transfer of the first type of electronic money.

Specifically, the electronic money terminal unit 200 includes a storage unit 210 for storing a series of electronic money applications, which are programs for executing the electronic money service including charging, payment, and transfer of a predetermined type of electronic money, according to the types of the electronic money applications, a card reader unit 220 for reading the electronic money card unit 100 storing the first type of electronic money among multiple types of electronic money, a reading unit 230 for reading application identification information corresponding to the first type of electronic money based on a result of the reading of the electronic money card unit 100, and an execution unit 240 for extracting the first type electronic money application corresponding to the read application identification information from the storage unit 210 and executing the extracted electronic money application to process a predetermined electronic money service.

The reading unit 230 determines, with a first priority in processing, if the read application identification information corresponds to a preset default type application set as a default. As a result of the determination, when the read application identification information does not correspond to the preset default type application, the reading unit 230 additionally determines if the read application identification information corresponds to the other types of electronic money applications among the stored electronic money applications.

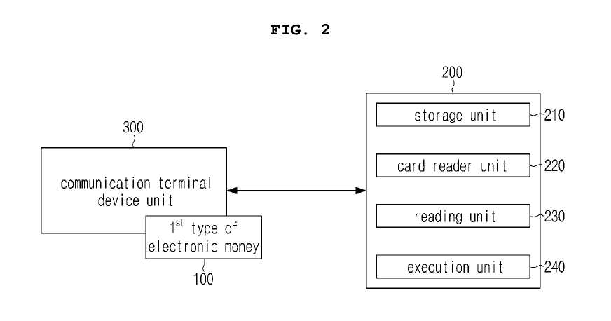

FIG. 2 is a block diagram illustrating another type of electronic money card unit 100, which is an Integrated Circuit (IC) module mounted or tagged in a communication terminal device unit 300. As shown in FIG. 2 as an example, when the electronic money card unit 100 is not a separate unit carried by a user, such as a plastic card, but is an IC module, the system for identifying multiple types of electronic money may further include a communication terminal device unit 300, which is provided or tagged with such an IC module and performs a communication for processing a predetermined electronic money service with the electronic money terminal unit 200.

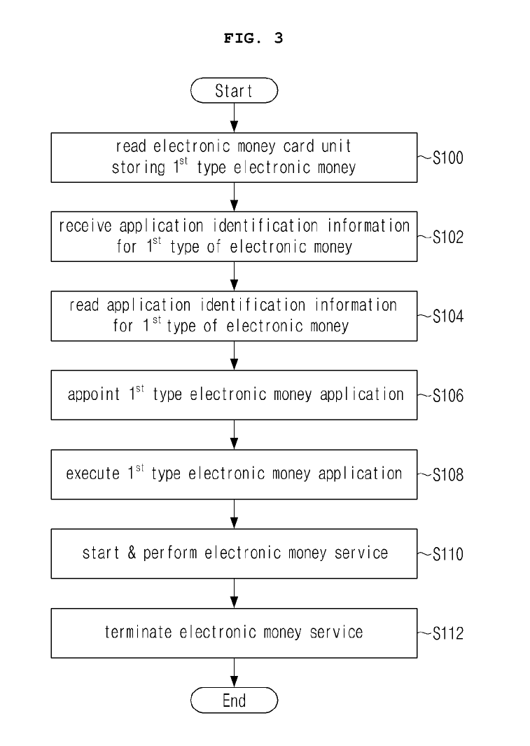

FIG. 3 is a flowchart illustrating an operation of the system for identifying multiple types of electronic money shown in FIG. 1. In the method for identifying multiple types of electronic money as shown in FIG. 3, the electronic money terminal unit 200 first reads the electronic money card unit 100 storing the first type of electronic money (step S100).

Then, the electronic money terminal unit 200 obtains application identification information of the first type of electronic money (e.g. ID of an electronic money application relating to the first type of electronic money) from the read information (step S102), and reads the application identification information of the first type of electronic money (step S104).

As a result of the reading, the electronic money terminal unit 200 appoints the first type electronic money application corresponding to the read application identification information among the multiple types of electronic money applications stored in the electronic money terminal unit 200 (step S106), and then executes the appointed first type electronic money application (step S108).

Thereafter, the electronic money terminal unit 200 provides a predetermined electronic money service through the first type electronic money application to a user, so that the user can use the electronic money service (step S110).

When use of the electronic money service by the user is completed, the process described above is also terminated (step S112).

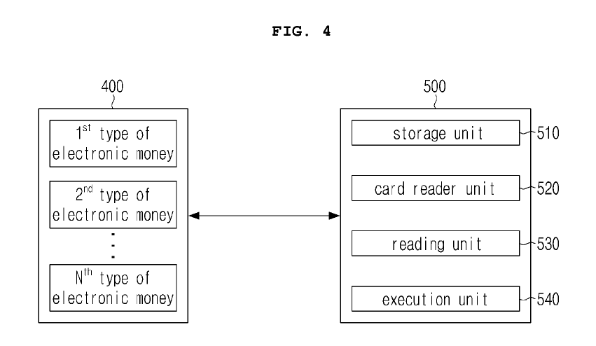

FIG. 4 is a block diagram illustrating a system for identifying multiple types of electronic money according to another embodiment of the present invention. The system for identifying multiple types of electronic money according to another embodiment of the present invention includes an electronic money card unit 400 storing multiple types of electronic money, and an electronic money terminal unit 500, which reads the electronic money card unit 400, reads application identification information (e.g. IDs) corresponding to the multiple types of electronic money, determines with a first priority if the read application identification information includes default type application identification information set as a default. When the read application identification information includes the default type application identification information set as a default, the electronic money terminal unit 500 executes with a first priority a default electronic money application corresponding to the default type application identification information among the stored electronic money applications, so as to process an electronic money service including charging, payment, and transfer of the default electronic money corresponding to the default type application identification information.

Although the electronic money terminal unit 500 executes with a first priority the default electronic money application when there is the default type application identification information, it is also preferred to prepare a menu for changing to another electronic money type which a user desires to use when the user expresses a desire for the change during the execution.

Specifically, the electronic money terminal unit 500 includes a storage unit 510 for storing electronic money applications, which are a series of programs for executing the electronic money service including charging, payment, and transfer of a predetermined type of electronic money, according to the types of the electronic money applications, a card reader unit 520 for reading the electronic money card unit 400 storing two or more different types of electronic money, a reading unit 530 for reading application identification information corresponding to the multiple types of electronic money based on a result of the reading of the electronic money card unit 400, and an execution unit 540 for determining with a first priority if the read application identification information includes default type application identification information set as a default. When the read application identification information includes the default type application identification information set as a default, the execution unit 540 executes with a first priority a default electronic money application corresponding to the default type application identification information among the stored electronic money applications, so as to process a predetermined electronic money service.

The reading unit 530 determines, with a first priority in processing, if the read application identification information corresponds to a preset default type electronic money application set as a default. As a result of the determination, when the read application identification information does not correspond to the preset default type electronic money application set as a default, the reading unit 530 additionally determines if the read application identification information corresponds to one of remaining types of electronic money applications among the stored electronic money applications.

As a result of the additional determination, when there is one type of compatible electronic money application capable of providing the electronic money service, which matches with the read application identification information, the execution unit 240 appoints and executes the compatible electronic money application, so as to process the electronic money service which the user wants.

Meanwhile, as a result of the additional determination, when there are two or more types of compatible electronic money applications capable of providing the electronic money service, which match with the read application identification information, the execution unit 240 provides the user with a guide for the two or more electronic money applications so that the user can select and appoint one electronic money application among the two or more compatible electronic money applications, and then executes the electronic money application appointed by the user, so as to process the electronic money service which the user wants.

According to an alternative scheme, as a result of the additional determination, when there are two or more types of compatible electronic money applications capable of providing the electronic money service, which correspond to the read application identification information, the execution unit 240 may determine priorities of the compatible electronic money applications based on criteria including a balance criterion, a point criterion, and a discount rate criterion, appoint a compatible electronic money application having the highest priority, and executes the appointed compatible electronic money application among the electronic money applications stored in the storage unit 510, so as to process a predetermined electronic money service.

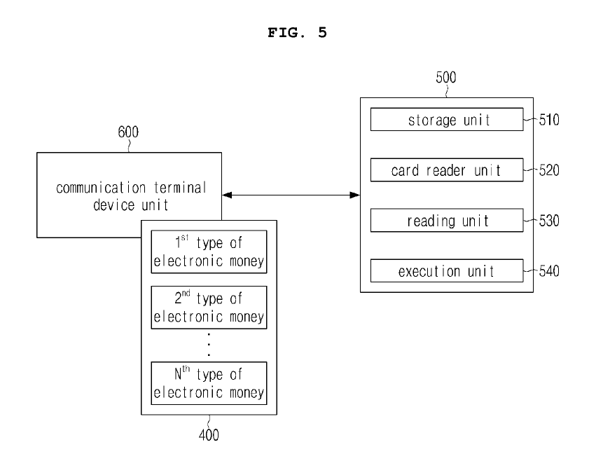

FIG. 5 is a block diagram illustrating another type of electronic money card unit 400, which is an Integrated Circuit (IC) module mounted or tagged in a communication terminal device unit 600. As shown in FIG. 5 as an example, when the electronic money card unit 400 is not a separate unit carried by a user, such as a plastic card, but is an IC module, the system for identifying multiple types of electronic money may further include a communication terminal device unit 600, which is provided or tagged with such an IC module and performs a communication for processing a predetermined electronic money service with the electronic money terminal unit 500.

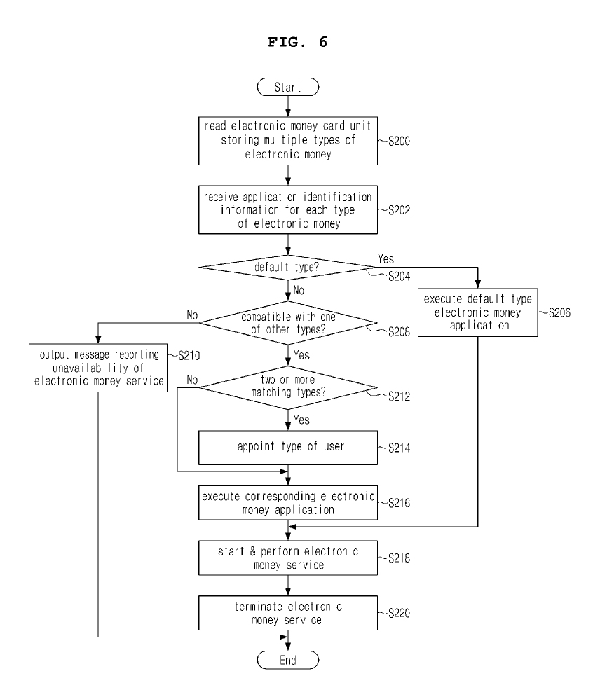

FIG. 6 is a flowchart illustrating an operation of the system for identifying multiple types of electronic money shown in FIG. 4. In the method for identifying multiple types of electronic money as shown in FIG. 6, the electronic money terminal unit 500 first reads the electronic money card unit 400 storing multiple types of electronic money (step S200).

Then, the electronic money terminal unit 500 obtains application identification information of the multiple types of electronic money (e.g. ID of an electronic money application relating to the first type of electronic money, ID of an electronic money application relating to the second type of electronic money, and ID of an electronic money application relating to the N^{th} type of electronic money) from the read information (step S202), reads the application identification information of each type of electronic money, and determines with a first priority if there is default type application identification information set as a default (step S204).

As a result of the determination in step S204, when there is default type application identification information set as a default, the electronic money terminal unit 500 appoints and executes a default electronic money application corresponding to the default type application identification information (step S206).

As a result of the determination in step S204, when there is no default type application identification information set as a default, the electronic money terminal unit 500 determines if the read application identification information matches with the other types of electronic money applications among the stored electronic money applications (step S208).

As a result of the determination in step S208, when there is no matching application identification information, the electronic money terminal unit 500 generates a message reporting the unavailability of the electronic money service and displays the message on a screen of the electronic money terminal unit 500 (step S210).

As a result of the determination in step S208, when there is at least one type of matching application identification information, the electronic money terminal unit 500 determines if there are two or more types of matching application identification information (step S212). When there is only one type of matching application identification information, the electronic money terminal unit 500 appoints and executes the corresponding electronic money application (steps S214 and S216). However, when there are two or more types of matching application identification information, the electronic money terminal unit 500 provides the user with a guide for the two or more types of matching application identification information for user's selection and executes an electronic money application corresponding to the selected type (steps S214 and S216).

Thereafter, the electronic money terminal unit 500 provides a predetermined electronic money service through the appointed or selected electronic money application to the user, so that the user can use the electronic money service (step S218).

When use of the electronic money service by the user is completed, the process described above is also terminated (step S220).

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A system for identifying multiple types of electronic money, the system comprising:
an electronic money card unit for storing a first type of electronic money; and
an electronic money terminal unit for reading application identification information corresponding to the first type of electronic money from the electronic money card unit, executing a first type electronic money application corresponding to the read application identification information among stored electronic money applications, and processing an electronic money service including charging, payment, and transfer of the first type of electronic money through the first type electronic money application.

2. The system for identifying multiple types of electronic money as claimed in claim 1, wherein when the electronic money card unit is an Integrated Circuit (IC) module, the system for identifying multiple types of electronic money further comprises a communication terminal device unit, which is provided or tagged with the IC module and performs a communication for processing the electronic money service with the electronic money terminal unit.

3. A system for identifying multiple types of electronic money, the system comprising:
an electronic money card unit for storing multiple types of electronic money; and
an electronic money terminal unit for reading application identification information corresponding to the multiple types of electronic money from the electronic money card unit, and, when the read application identification information includes default type application identification information, executing a default electronic money application corresponding to the default type application identification information among stored electronic money applications and processing an electronic money service including charging, payment, and transfer of the default electronic money corresponding to the default type application identification information.

4. The system for identifying multiple types of electronic money as claimed in claim 3, wherein when the electronic money card unit is an Integrated Circuit (IC) module, the system for identifying multiple types of electronic money further comprises a communication terminal device unit, which is provided or tagged with the IC module and performs a communication for processing the electronic money service with the electronic money terminal unit.

5. The system for identifying multiple types of electronic money as claimed in claim 3, wherein, when the read application identification information includes no default type application identification information, the electronic money terminal unit determines whether the multiple types of electronic money include a type of electronic money matching with the read application identification information, and executes an electronic money application corresponding to the type of electronic money matching with the read application identification information among the stored electronic money applications when the multiple types of electronic money include the type of electronic money matching with the read application identification information.

6. An electronic money terminal unit in a system for identifying multiple types of electronic money, the electronic money terminal unit comprising:
a storage unit for storing electronic money applications for executing an electronic money service including charging, payment, and transfer of one type of electronic money among the multiple types of electronic money, according to types of the electronic money applications;
a card reader unit for reading an electronic money card storing a first type of electronic money among the multiple types of electronic money;
a reading unit for reading application identification information corresponding to the first type of electronic money; and
an execution unit for extracting a first type electronic money application corresponding to the read application identification information from the storage unit and executing the extracted electronic money application to process the electronic money service.

7. The electronic money terminal unit as claimed in claim 6, wherein the reading unit determines whether the read application identification information corresponds to a preset default type application set as a default, and, when the read application identification information does not correspond to the preset default type application, the reading unit additionally determines if the read application identification information corresponds to one of remaining electronic money applications among the stored electronic money applications.

8. An electronic money terminal unit in a system for identifying multiple types of electronic money, the electronic money terminal unit comprising:
a storage unit for storing electronic money applications for executing an electronic money service including charging, payment, and transfer of a predetermined type of electronic money among the multiple types of electronic money, according to types of the electronic money applications;
a card reader unit for reading an electronic money card storing two or more types of electronic money;
a reading unit for reading application identification information corresponding to each of the two or more types of electronic money; and
an execution unit for determining whether the read application identification information includes default type application identification information set as a default, and, when the read application identification information includes the default type application identification information, executing a default electronic money application corresponding to the default type application identification information among the stored electronic money applications, so as to process a predetermined electronic money service.

9. The electronic money terminal unit as claimed in claim 8, wherein the reading unit determines whether the read application identification information corresponds to a preset default type application set as a default, and, when the read application identification information does not correspond to the preset default type application, the reading unit additionally determines whether the read application identification information corresponds to one of remaining electronic money applications among the stored electronic money applications.

10. The electronic money terminal unit as claimed in claim 9, wherein, as a result of additional determination, when there is one type of compatible electronic money application capable of providing the electronic money service, which matches with the read application identification information, the execution unit executes the compatible electronic money application among the electronic money applications stored in the storage unit, so as to process the electronic money service.

11. The electronic money terminal unit as claimed in claim 9, wherein, when there are two or more types of compatible electronic money applications capable of providing the electronic money service, which match with the read application identification information, the execution unit executes an electronic money application appointed and selected by the user from the two or more electronic money applications among the electronic money applications stored in the storage unit, so as to process the electronic money service.

12. The electronic money terminal unit as claimed in claim 9, wherein, when there are two or more types of compatible electronic money applications capable of providing the electronic money service, which match with the read application identification information, the execution unit determines priorities of the compatible electronic money applications based on criteria including a balance criterion, a point criterion, and a discount rate criterion, appoints a compatible electronic money application having a highest priority, and executes the appointed compatible electronic money application among the electronic money applications stored in the storage unit, so as to process the electronic money service.

13. A method for identifying multiple types of electronic money, the method comprising the steps of:
reading an electronic money card storing a first type of electronic money among the multiple types of electronic money;
reading application identification information corresponding to the first type of electronic money;
appointing a first type electronic money application corresponding to the application identification information from a storage unit storing electronic money applications for executing an electronic money service including charging, payment, and transfer of a predetermined type of electronic money among the multiple types of electronic money, according to types of the electronic money applications; and
executing the first type electronic money application to process the electronic money service.

14. The method for identifying multiple types of electronic money as claimed in claim 13, wherein the step of reading application identification information comprises the steps of:
determining whether the read application identification information corresponds to a preset default type application set as a default; and
when the read application identification information does not correspond to the preset default type application, additionally determining whether the read application identification information corresponds to one of remaining electronic money applications among the stored electronic money applications.

15. A method for identifying multiple types of electronic money, the method comprising the steps of:
reading an electronic money card storing two or more types of electronic money;
reading application identification information corresponding to each of the two or more types of electronic money;
when a result of reading of the application identification information shows that the read application identification information includes default application identification information set as a default, appointing a default electronic money application corresponding to the default application identification information from a storage unit storing electronic money applications for executing an electronic money service including charging, payment, and transfer of a predetermined type of electronic money among the multiple types of electronic money including the two or more types of electronic money, according to types of the electronic money applications; and
executing the default electronic money application to process the electronic money service.

16. The method for identifying multiple types of electronic money as claimed in claim 15, wherein the step of reading the application identification information comprises the steps of:
determining whether the read application identification information corresponds to the default application identification information set as a default; and
when the read application identification information does not correspond to the preset default type application, additionally determining whether the read application identification information corresponds to one of remaining electronic money applications among the stored electronic money applications.

17. The method for identifying multiple types of electronic money as claimed in claim 15, wherein the step of executing the default electronic money application comprises the steps of:
when a result of additional determination shows that there is one type of compatible electronic money application capable of providing the electronic money service, which matches with the read application identification information, executing the compatible electronic money application among the electronic money applications stored in the storage unit, so as to process the electronic money service.

18. The method for identifying multiple types of electronic money as claimed in claim 15, wherein the step of executing the default electronic money application comprises the step of:
when a result of additional determination shows that there are two or more types of compatible electronic money applications capable of providing the electronic money service, which match with the read application identification information, executing an electronic money application appointed and selected by the user from the two or more electronic money applications among the electronic money applications stored in the storage unit, so as to process the electronic money service.

19. The method for identifying multiple types of electronic money as claimed in claim 15, wherein the step of executing the default electronic money application comprises the steps of:
when a result of additional determination shows that there are two or more types of compatible electronic money applications capable of providing the electronic money service, which match with the read application identification information, determining priorities of the compatible electronic money applications based on criteria including a balance criterion, a point criterion, and a discount rate criterion, appoints a compatible electronic money application having a highest priority; and
executing the appointed compatible electronic money application among the electronic money applications stored in the storage unit, so as to process the electronic money service.
